(19) United States
(12) Patent Application Publication
(10) Pub. No.: US 2022/0340388 A1
(43) Pub. Date: Oct. 27, 2022

(54) CONTAINERS, BLANKS, AND METHODS FOR DISPENSING WEB MATERIAL

(71) Applicant: REYNOLDS CONSUMER PRODUCTS LLC, Lake Forest, IL (US)

(72) Inventors: Taylor A. KIZER, Chicago, IL (US); Kyle RUSSO, Arvada, CO (US); Terrill Mathew PORTER, Chester, VA (US); Mogieannah Beth BROWN-IVEY, Chesterfield, VA (US); Harry FITHIAN, Langhorne, PA (US)

(73) Assignee: REYNOLDS CONSUMER PRODUCTS LLC, Lake Forest, IL (US)

(21) Appl. No.: 17/728,300

(22) Filed: Apr. 25, 2022

Related U.S. Application Data
(60) Provisional application No. 63/180,023, filed on Apr. 26, 2021.

(51) Int. Cl. B65H 35/00; B65D 85/671; B65D 83/08; B31B 50/26

(52) U.S. Cl. CPC B65H 35/002; B65D 85/671; B65D 83/0882; B31B 50/26; B65H 35/0086; B31B 2120/102

(57) ABSTRACT

Container including base portion defining compartment. Base portion includes bottom panel defining bottom of compartment, front base panel defining front of compartment and extending upwardly from bottom panel to top edge defining recessed area. Base portion further includes back panel extending from bottom panel to define a back of compartment, and first and second side tabs extending between bottom panel, front base panel, and back panel at opposing sides thereof to define opposing sides of compartment. Container further includes lid portion moveable between open position for access to compartment and closed position. Lid portion includes top panel defining top of lid portion, top panel hingedly-coupled to back panel, and front lid panel extending from the top panel. Front lid panel covers recessed area in closed position, and in open position web material can be dispensed from compartment through recessed area.

### CROSS-REFERENCE TO RELATED APPLICATION

This application claim priority to U.S. Provisional Application Ser. No. 63/180,023 filed Apr. 26, 2021, the entire contents of which are hereby incorporated by reference in their entirety.

### BACKGROUND

The disclosed subject matter relates to containers for storing and dispensing web material, such as butcher paper or other such products.

Various web materials, such as paper, plastic wrap, or other sheet type products, are available in roll form, such as products used to cover or wrap items. For example, butcher paper is often used to wrap meat for cooking or smoking purposes to, for example, seal in moisture or prevent the exterior of meat from becoming too smoky or too dark.

A variety of dispensing containers are known to hold rolls of paper or sheet material, such as wax paper, parchment paper, aluminum foil, plastic wrap and the like. However, conventional dispensing containers generally are not configured to secure a roll therein. Furthermore, properties of certain paper, such as butcher paper, can cause undesirable effects, such as stretching or clumping of the butcher paper before used for intended purpose. Additionally, dispensed web material can be difficult to separate from the roll, particularly as web material is frequently dispensed while simultaneously handling items to be wrapped in the dispensed web material, such as food items.

It is therefore desirable to provide a container that can securely contain web material therein and allow for easy dispensing and cutting of the web material.

Additionally, it is desirable to provide a blank for forming such a dispensing container, which can reduce manufacturing complexity, as well as the number of components and costs associated with manufacture of the dispensing container.

### SUMMARY

The purpose and advantages of the disclosed subject matter will be set forth in and apparent from the description that follows, as well as will be learned by practice of the disclosed subject matter. For purpose of illustration and not limitation, the various embodiments described herein relate to containers and methods for storing and dispensing a paper or sheet material packed on a roll, such as butcher paper or other such products. Additional advantages of the disclosed subject matter will be realized and attained by the containers and methods particularly pointed out in the written description and claims hereof, as well as from the appended drawings.

To achieve these and other advantages, and in accordance with the purpose of the disclosed subject matter, as embodied and broadly described, the disclosed subject matter includes containers and methods for dispensing web material and blanks for forming such containers.

Containers in accordance with the disclosed subject matter include a base portion defining a compartment. The base portion includes a bottom panel defining a bottom of the compartment, a front base panel defining a front of the compartment and extending upwardly from the bottom panel to a top edge defining a recessed area. The base portion further includes a back panel extending from the bottom panel to define a back of the compartment, and first and second side tabs extending between the bottom panel, the front base panel, and the back panel at opposing sides thereof to define opposing sides of the compartment.

Containers in accordance with the disclosed subject matter further include a lid portion. The lid portion is moveable between an open position for access to the compartment and a closed position. The lid portion includes a top panel defining a top of the lid portion, the top panel hingedly-coupled to the back panel. The lid portion further includes a front lid panel extending from the top panel. The front lid panel covers the recessed area in the closed position, and in the open position web material can be dispensed from the compartment through the recessed area.

In accordance with an aspect of the disclosed subject matter, the front base panel can have a front base panel height defined between the top edge and the bottom panel, and each of the first and second side tabs can have a top edge and a bottom edge with a side tab height defined therebetween. The front base panel height can be less than the side tab height of each of the first and second side tabs to define the recessed area therein.

In accordance with another aspect of the disclosed subject matter, the container can further include a cutter with a sliding rail disposed on the front base panel in the recessed area. The cutter can have a cutter height defined between the bottom panel and a high point of the cutter, and the cutter height can be less than the side tab height of each of the first and second side tabs.

In accordance with another aspect of the disclosed subject matter, each of the first and second side tabs can have a recess notch defined therein between the top edge of the front base panel and the top edge of the respective front base side tab.

In accordance with another aspect of the disclosed subject matter, a roll of web material, such as butcher paper, can be contained within the compartment.

The disclosed subject matter further includes blanks for forming containers. Blanks in accordance with the disclosed subject matter include a base portion having a front base panel having a top edge and a front base panel fold line opposite the top edge. The front base panel further includes opposing first and second front base side fold lines, a first front base side tab extending from the first front base side fold line, and a second front base side tab extending from the second front base side fold line. The base portion further includes a bottom panel extending from the front base panel fold line to a back base panel fold line. The bottom panel includes opposing first and second bottom side fold lines, a first bottom side tab extending from the first bottom side fold line, and a second bottom side tab extending from the second bottom side fold line. The first bottom side tab includes a first outer side tab segment extending from the first bottom side fold line to a first outer bottom side tab fold line, a first bottom side connection tab segment extending from the first outer bottom side tab fold line to a first bottom side connection tab fold line, and a first inner bottom side tab segment extending from the first bottom side connection tab fold line. The second bottom side tab includes a second outer side tab segment extending from the second bottom side fold line to a second outer bottom side tab fold line, a second bottom side connection tab segment extending from the second outer bottom side tab fold line to a second bottom side connection tab fold line, and a second inner bottom side tab segment extending from the second bottom side connection tab fold line.

The base portion further includes a back panel extending from the back base panel fold line to a base-lid hinge line. The back panel includes opposing first and second back side fold lines, a first back side tab extending from the first back side fold line, and a second back side tab extending from the second back side fold lines.

Blanks in accordance with the disclosed subject matter further include a lid portion. The lid portion includes a top panel extending from the base-lid hinge line to a top front fold line, and a front lid panel extending from the top front fold line.

In accordance with an aspect of the disclosed subject matter, the blank can further include a reinforcement panel extending from the top edge of the front base panel and the top edge can be a top edge fold line.

In accordance with another aspect of the disclosed subject matter, the top edge of the blank can define a recessed area.

In accordance with another aspect of the disclosed subject matter, the front base panel can have a front base panel height defined between the top edge and the front base panel fold line, and each of the first and second front base side tabs can have a top edge and a bottom edge with a front base side tab height defined therebetween. The front base panel height can be less than the front base side tab height of each of the first and second front base side tabs to define the recessed area therein.

In accordance with another aspect of the disclosed subject matter each of the first and second front base side tabs can include a recess notch therein between the top edge of the front base panel and the top edge of the respective front base side tab.

The disclosed subject matter further includes methods of forming blanks into containers. Methods in accordance with the disclosed subject matter include providing a blank as described above. Methods in accordance with the disclosed subject matter further include folding the front base panel about the front base panel fold line to define a front of a compartment and folding the back panel about the back base panel fold line to define a back of the compartment. Methods in accordance with the disclosed subject matter further include folding the first front base side tab about the first front base side fold line, the first back side tab about the first back side fold line, and the first bottom side tab about the first bottom side fold line, first outer bottom side tab fold line, and the first bottom side connection tab fold line to define a first side of the compartment. Methods in accordance with the disclosed subject matter further include folding the second front base side tab about the second front base side fold line, the second back side tab about the second back side fold line, and the second bottom side tab about the second bottom side fold line, second outer bottom side tab fold line and the second bottom side connection tab fold line to define a second side of the compartment. Methods in accordance with the disclosed subject matter further include folding the top panel about the base-lid hinge line to define a top of the compartment.

The disclosed subject matter further includes a method of dispensing web material from a roll. Methods in accordance with the disclosed subject matter include providing a container in accordance with the disclosed subject matter and disposing a roll of web material in the container and dispensing the web material from the roll through the recessed area with the lid portion in the open position.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the systems and methods of the disclosed subject matter. Together with the description, the drawings serve to explain the principles of the disclosed subject matter.

### BRIEF DESCRIPTION OF THE DRAWINGS

FIG. 1A is a front, perspective view of a container in accordance with the disclosed subject matter, shown with the lid portion in a closed position.

FIG. 1B is a front perspective view of the container of FIG. 1 with the lid portion removed for purpose of illustration and a cutter being disposed on the front base panel in the recessed area.

FIG. 1C is a side cross section view of the container of FIG. 1 taken along line 1C-1C as depicted in FIG. 1 and shown with the lid portion in an open position, the cutter disposed on the front base panel in the recessed area, and a roll of web material disposed in the compartment.

FIG. 2A is a front view of the container of FIG. 1, shown with the lid portion in an open position.

FIG. 2B is a top view of the container of FIG. 1 shown with a roll of web material disposed in the compartment.

FIG. 3 is a back view of the container of FIG. 1, shown with the lid portion in the open position.

FIG. 4 is a front perspective view of the container of FIG. 1 shown with the lid portion in the open position and a portion of web material being dispensed from a roll through the recessed area and cut from the roll using a cutter.

FIG. 5 is a side detail view of the cutter and sliding rail of the container of FIG. 1.

FIG. 6A is a top detail view of the cutter and sliding rail of the container of FIG. 1.

FIG. 6B is a front, perspective view of the cutter and sliding rail of the container of FIG. 1.

FIG. 7 is a plan view of a blank in accordance with the disclosed subject matter.

FIG. 8 is a schematic plan view of the blank of FIG. 7, in a partially assembled configuration with the first and second back side mounting segments secured to the back panel.

FIG. 9 is a schematic plan view of the blank of FIG. 7 in a partially assembled configuration with the first and second back side tabs in a folded configuration.

FIG. 10 is a schematic plan view of the blank of FIG. 7 in a partially assembled configuration illustrating the first and second back side tabs in a folded configuration and the back panel in an upright position to define a back of the compartment.

FIG. 11 is a partial detail view of FIG. 10 depicting the front base panel moving towards an upright position to define a front of the compartment and a second front base side tab moving towards a folded configuration to define a side of the compartment.

FIG. 12A is a partial schematic plan view of the blank of FIG. 7 in a partially assembled configuration with the first bottom side tab moving towards a folded configuration to define a side of the compartment.

FIG. 12B is a partial schematic plan view of the blank of FIG. 7 in an assembled configuration with the first bottom side tab in a folded configuration to define a side of the compartment.

FIG. 13 is a plan view of another blank in accordance with the disclosed subject matter.

FIG. 14 is a plan view another blank in accordance with the disclosed subject matter.

FIG. 15 is a plan view of another blank in accordance with the disclosed subject matter.

### DETAILED DESCRIPTION

Reference will now be made in detail to the various exemplary embodiments of the disclosed subject matter, which are illustrated in the accompanying drawings. The structure and corresponding method of operation of the disclosed subject matter will be described in conjunction with the detailed description of the system. The accompanying drawings, where like reference numerals refer to identical or functionally similar elements throughout the separate views, serve to further illustrate various embodiments and to explain various principles and advantages all in accordance with the disclosed subject matter.

The disclosed subject matter is generally directed to containers, blanks, and methods for dispensing web material, such as butcher paper. Containers for dispensing web material in accordance with the disclosed subject matter generally include a base portion defining a compartment. The base portion includes a bottom panel defining a bottom of the compartment, a front base panel defining a front of the compartment and extending upwardly from the bottom panel to a top edge defining a recessed area. The base portion further includes a back panel extending from the bottom panel to define a back of the compartment, and first and second side tabs extending between the bottom panel, the front base panel, and the back panel at opposing sides thereof to define opposing sides of the compartment.

Containers in accordance with the disclosed subject matter further include a lid portion. The lid portion is moveable between an open position for access to the compartment and a closed position. The lid portion includes a top panel defining a top of the lid portion, the top panel hingedly-coupled to the back panel. The lid portion further includes a front lid panel extending from the top panel. The front lid panel covers the recessed area in the closed position, and in the open position web material can be dispensed from the compartment through the recessed area.

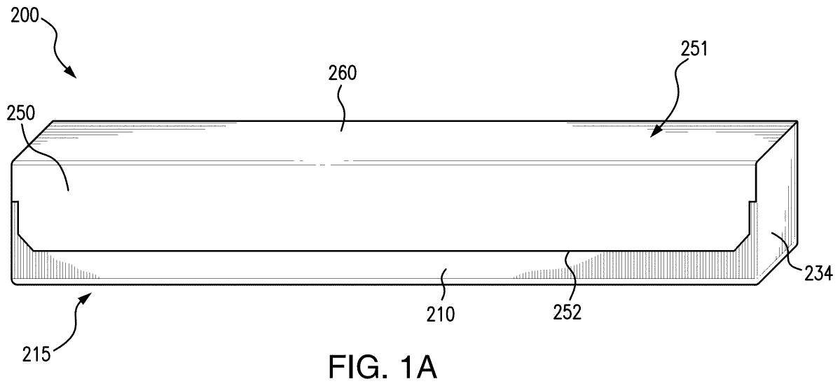

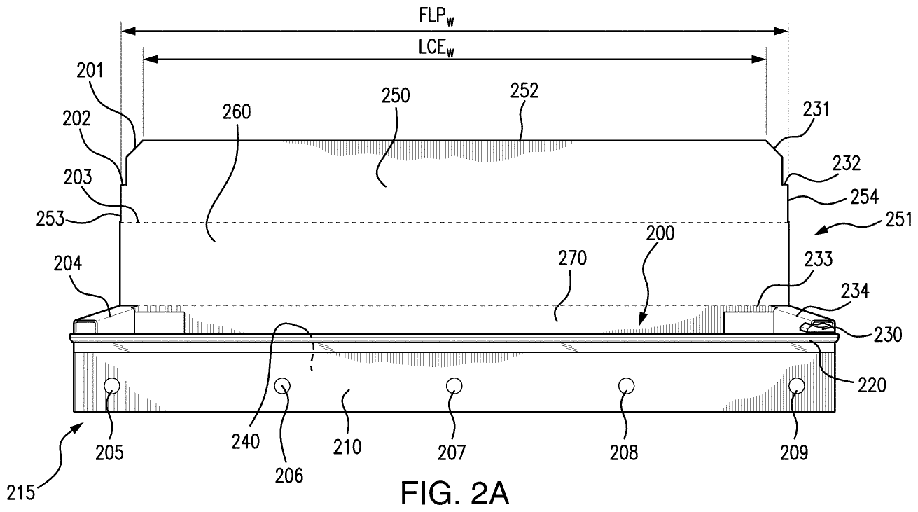

For purpose of explanation and illustration, and not limitation, exemplary containers and blanks in accordance with the disclosed subject matter are shown in FIGS. 1-20. Containers, blanks, and methods in accordance with the disclosed subject matter are suitable for use with a wide variety of webbed material, including for example, butcher paper, aluminum foil, tape, parchment paper, wax paper, aluminum foil, fabric and the like.

For purpose of illustration, and not limitation, reference will be made to an exemplary embodiment of a container, or dispensing container, for dispensing web material. As used herein, the terms “front,” “end,” “side,” “top,” and “bottom” are used for the purpose of illustration only, and not limitation. That is, it is recognizable that the terms “front,” “end,” “side,” “top,” and “bottom” are interchangeable and are merely used herein as a point of reference. Additionally, as used herein, the term “score line” includes a line incised or otherwise cut into, either partially or entirely through, the surface of the container or the blank used to form the container of the disclosed subject matter, and the term “fold line” includes a line of weakness or bending formed in the surface of the container or the blank used to form the container of the disclosed subject matter.

For purpose of illustration and not limitation, an exemplary embodiment of a container 200 is shown in FIGS. 1A-4. In accordance with the disclosed subject matter, and with reference to FIGS. 1A-1C, the container 200 includes a base portion 215 defining a compartment 240. The base portion 215 includes a bottom panel 225 defining a bottom of the compartment 240. The base portion 215 further includes a front base panel 210 defining a front of the compartment 240. The front base panel 210 extends upwardly from the bottom panel 225 to a top edge 213 defining a recessed area 235. The base portion 215 further includes a back panel 270 extending from the bottom panel 225 to define a back of the compartment 240.

In accordance with the disclosed subject matter, the container 200 includes first and second side tabs defining opposing sides of the compartment 240. The container 200 includes a first side tab 204 extending between the bottom panel 225, the front base panel 210, and the back panel 270 to define a first side of the compartment 240. And the container 200 includes a second side tab 234 extending between the bottom panel 225, the front base panel 210, and the back panel 270 to define a second, opposing, side of the compartment 240. The first and second side tabs 204 and 234 can each include front base panel side tabs, bottom panel side tabs, and back panel side tabs, as described further herein.

As embodied herein, and with reference to FIG. 1B, the front base panel 210 of the container 200 can have a front base panel height (FBPh) defined between the top edge 213 and the bottom panel 225. As further embodied herein, the first side tab 204 can have a first side tab top edge 214 and a first side tab bottom edge 216 with a first side tab height (STh) defined therebetween, and the second side tab 234 can have a second side tab top edge 244 and a second side tab bottom edge 246 with a second side tab height (STh) defined therebetween. As embodied herein the front base panel height (FBPh) can be less than the side tab height (STh) of each of the first and second side tabs 204 and 234 to define the recessed area 235 therein.

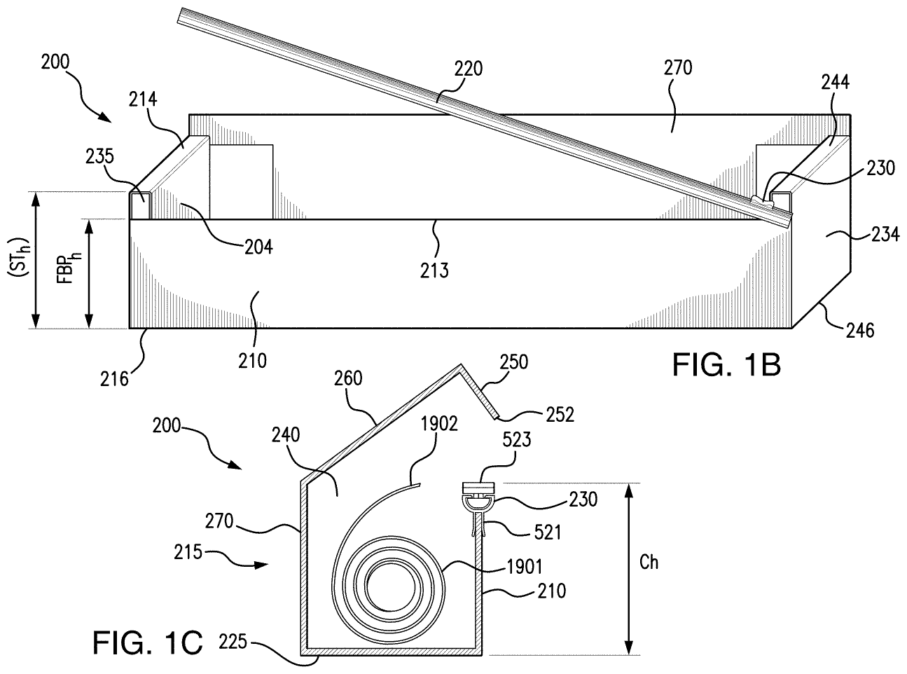

As further embodied herein, and with reference to FIG. 2B, the first side tab 204 can include a first recess notch 236 therein between the top edge 213 of the front base panel 210 and the first side tab top edge 214. Further, the second side tab 234 can include a second recess notch 237 therein between the top edge 213 and the second side tab top edge 244. As embodied herein, the recessed area 235 can extend into the first and second recess notches 236 and 237. As described further herein, the first and second recess notches 236 and 237 can extend through a portion of the first and second side tabs, or alternatively, can extend through the entirety of the first and second side tabs 204 and 234.

As further embodied herein, the first and second side tabs 204 and 234 can each have a side tab width (STw). The side tab width can be defined between outer side tab segments and inner bottom side tab segments, as further described herein. The side tab width (STw) can be selected based on the dimensions of the roll of web material to be dispensed and the configuration of the cutter, as further described herein. For example, the side tab width (STw) can be selected to position the roll of web material 1901 in the center of the compartment 240. Additionally or alternatively, the side tab width (STw) can be selected to accommodate a cutter within the first and second recess notches 236 and 237, respectively.

In accordance with the disclosed subject matter, the container 200 includes a lid portion 251, the lid portion 251 moveable between an open position for access to the compartment 240 and a closed position. The lid portion 251 includes a top panel 260 defining a top of the lid portion 251. The top panel 260 is hingedly coupled to the back panel 270. As embodied herein, the top panel 260 can be hingedly coupled to the back panel 270 at a fold line 233.

The lid portion 251 further includes a front lid panel 250 extending from the top panel 260 to a lid closing edge 252. As embodied herein, the front lid panel 250 and the top panel 260 can be coupled at a fold line 203. As embodied herein, the front lid panel 250 can include a first front lid side edge 253 and a second front lid side edge 254 defining a front lid panel width (FLPw) therebetween. The front lid panel 250 can further include a first front lid side notch 201 defined between the lid closing edge 252 and the first front lid side edge 253, and a second front lid side notch 231 defined between the lid closing edge 252 and the second front lid side edge 254. As embodied herein, the lid closing edge 252 can have a lid closing edge width (LCEw) less than the front lid panel width (FLPw).

The first front lid side notch 201 and the second front lid side notch 231 can have any desirable shape. For purpose of example and not limitation, the first and second front lid side notches can have a curved shape extending between the lid closing edge 252 and the first front lid side edge 253 and second front lid side edge 254, respectively. Alternatively, and as embodied herein, the first front lid side notch 201 and the second front lid side notch 231 can have an angled shape extending between the lid closing edge 252 and the first front lid side edge 253 and second front lid side edge 254, respectively. As further embodied herein, the first and second front lid side edges 253 and 254 can include setbacks 202 and 232 defined therein, as described further below. As embodied herein, the portion of the front lid panel 250 between setbacks 202 and 232 and the lid closing edge 252 can have a width smaller than the front lid panel width (FLPw) and can be inserted into the compartment with the lid in the closed position. The left side of the front lid panel 250 includes two notches 201 and 202, and the right side of the front lid panel 250 includes two notches 231 and 232.

As described above, the lid portion 251 of the container 200 is moveable between an open position for access to the compartment 240 and a closed position. With reference to FIG. 1A, the lid portion 251 is shown in a closed position, and with reference to FIG. 2A, the lid portion 251 is shown in an open position. The front lid panel 250 covers the recessed area 235 when the lid portion 251 is in the closed position, and in the open position web material 1901 can be dispensed from the compartment through the recessed area 235. As embodied herein, the top panel 260 can be perpendicular with the back panel 270 and can rest on the first and second side tab top edges 214 and 244 when the lid portion 251 is in the closed position. As further embodied herein, an adhesive, hook and loop, or other fastening means can be used to secure the lid portion in the closed position. For example and as embodied herein, glue material can be applied to glue points 205, 206, 207, 208, and 209 on the front base panel 210, and the glue material can engage with the front lid panel 250 when the lid portion 251 is in the closed position.

As embodied herein, web material can be contained within the compartment 240. As further embodied herein, the web material 1901 can be packaged in a roll. The web material 1901 can include, for example, plastic wrap, foil, wax paper, parchment paper, wrapping paper, or the like. As embodied herein, the web material can be a roll of butcher paper. As embodied herein, the roll of web material 1901 can be disposed in the compartment 240 in an overhand arrangement, with a free end 1902 of the web material 1901 extending over a top of the roll toward the front base panel 210. Alternatively, a roll of web material can be disposed in the container in an underhand arrangement with a free end of the web material extending up from the bottom of the roll toward the front base panel.

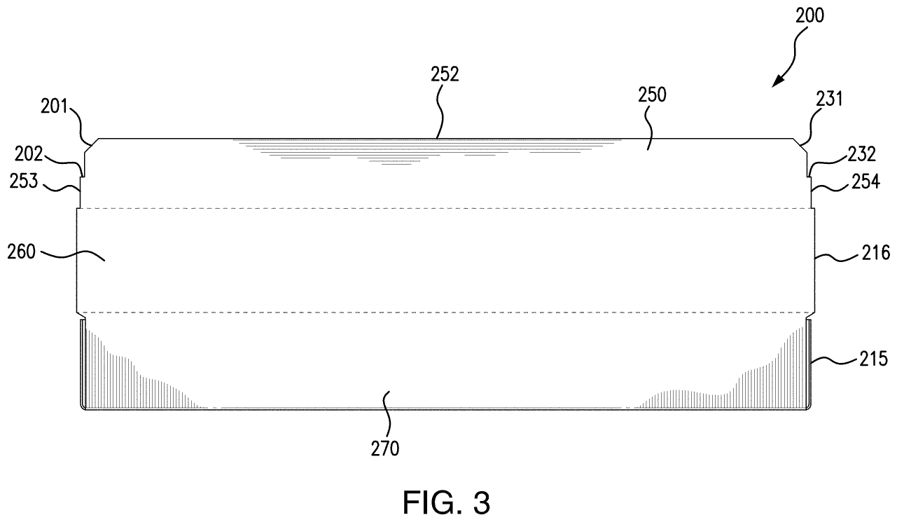

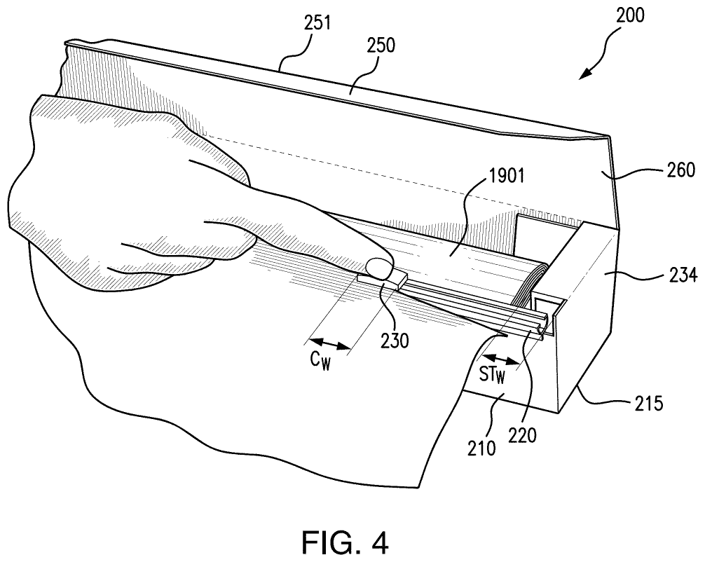

As further embodied herein, the container 200 can include a cutter 230. As further embodied herein, the cutter 230 can be disposed on the front base panel 210 in the recessed area 235. For example, the cutter 230 can include a sliding rail 220 having fins 521 as depicted in FIGS. 5-6B. The fins 521 can engage with the front base panel 210 to mount the sliding rail 220 and cutter to the front base panel 210. A variety of cutter assemblies are known and can be used with the dispensing container of the disclosed subject matter. For example, suitable cutter assemblies are described in U.S. Pat. Nos. 7,918,151 and 7,921,756, each of which is incorporated by reference herein in its entirety.

As embodied herein, and with reference to FIG. 1C, the cutter 230 can have a cutter height (Ch) defined between the bottom panel 225 and a cutter high point 523. The cutter height (Ch) can be less than the side tab height (STh) of each of the first and second side tabs 204 and 234. As embodied herein, the lid portion 251 can be moved to the closed position with the top panel 260 resting on the first and second side tab top edges 214 and 244 without interference between the cutter 230 and the lid portion 251.

As further embodied herein, the cutter 230 can have a cutter width (Cw). As described above, the side tab width (STw) can be greater than the cutter width (Cw) to accommodate the cutter 230 within the first and second recess notches 236 and 237, respectively. With the cutter 230 disposed within the first or second recess notch 236 or 237, web material 1901 can be dispensed through the recessed area 235 without interfering with the cutter 230. For example and as embodied herein, the web material 1901 can be dispensed through the recessed area 235 over the sliding rail 220 with the cutter 230 in the first or second recess notch 236 or 237. When the desired amount of web material 1901 has been dispensed, the cutter 230 can be slid across the sliding rail 220 to separate the dispensed web material 1901 from the roll.

The disclosed subject matter further includes methods for dispensing web material from a roll. Methods in accordance with the disclosed subject matter include providing a container in accordance with the disclosed subject matter. The container can have any of the features described herein. Methods in accordance with the disclosed subject matter further include disposing a roll of paper material in the container and dispensing the paper material from the roll through the recessed area with the lid portion in the open position.

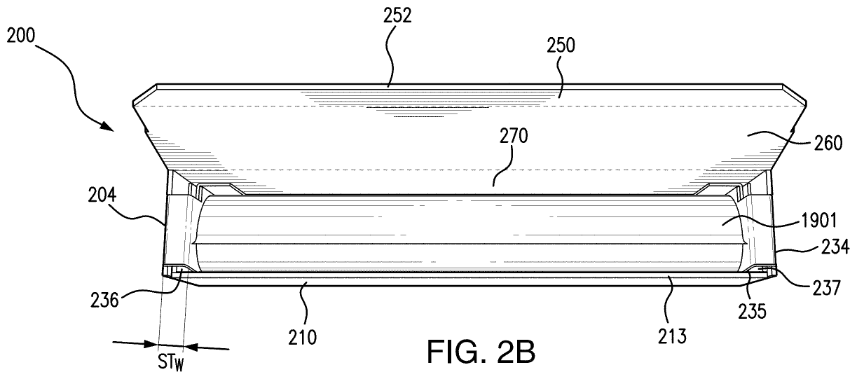

FIG. 4 depicts a web material 1901 being dispensed through the recessed area 235 of the container 200 with the lid portion 251 in the open position in accordance with the disclosed subject matter. As embodied herein, the web material can be butcher paper. As further embodied herein, dispensing the web material 1901 can include cutting web material from the roll using cutter 230. As described above, the cutter 230 can be disposed on the front base panel 210 in the recessed area 235. For purpose of example and not limitation, cutting the web material can include sliding the cutter 230 along sliding rail 220. As embodied herein, the cutter 230 can cut the web material 1901 as the cutter 230 slides on the sliding rail 220.

The disclosed subject matter further includes blanks for forming containers. Blanks in accordance with the disclosed subject matter include a base portion having a front base panel having a top edge and a front base panel fold line opposite the top edge. The front base panel further includes opposing first and second front base side fold lines, a first front base side tab extending from the first front base side fold line, and a second front base side tab extending from the second front base side fold line. The base portion further includes a bottom panel extending from the front base panel fold line to a back base panel fold line. The bottom panel includes opposing first and second bottom side fold lines, a first bottom side tab extending from the first bottom side fold line, and a second bottom side tab extending from the second bottom side fold line. The first bottom side tab includes a first outer side tab segment extending from the first bottom side fold line to a first outer bottom side tab fold line, a first bottom side connection tab segment extending from the first outer bottom side tab fold line to a first bottom side connection tab fold line, and a first inner bottom side tab segment extending from the first bottom side connection tab fold line. The second bottom side tab includes a second outer side tab segment extending from the second bottom side fold line to a second outer bottom side tab fold line, a second bottom side connection tab segment extending from the second outer bottom side tab fold line to a second bottom side connection tab fold line, and a second inner bottom side tab segment extending from the second bottom side connection tab fold line.

The base portion further includes a back panel extending from the back base panel fold line to a base-lid hinge line. The back panel includes opposing first and second back side fold lines, a first back side tab extending from the first back side fold line, and a second back side tab extending from the second back side fold lines.

Blanks in accordance with the disclosed subject matter further include a lid portion. The lid portion includes a top panel extending from the base-lid hinge line to a top front fold line, and a front lid panel extending from the top front fold line.

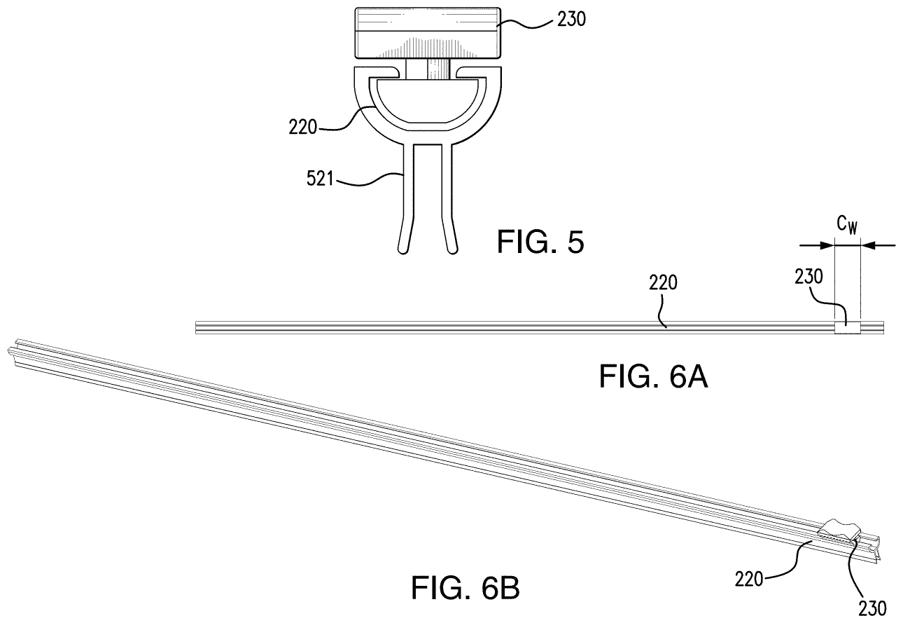

For purpose of illustration and not limitation, an exemplary embodiment of a blank 700 in accordance with the disclosed subject matter is shown in FIG. 7. The blank 700 includes a base portion 780 having a front base panel 735. The front base panel 735 includes a top edge 713, and a front base panel fold line 726 opposite the top edge 713. As embodied herein, the top edge 713 defines a recessed area 736. As further embodied herein, the top edge 713 defines a top edge fold line, and the blank 700 further includes a reinforcement panel 714 extending from the top edge 713. The reinforcement panel 714 can be folded around the top edge fold line when the blank 700 is assembled into a container to provide the top edge 713 with additional rigidity.

The front base panel 735 further includes opposing first and second front base side fold lines 747, 748. A first front base side tab 745 extends from the first front base side fold line 747, and a second front base side tab 746 extends from the second front base side fold line 748.

As embodied herein, the front base panel 735 can have a front base panel height (FBPh) defined between the top edge 713 and the front base panel fold line 726 and each of the first and second front base side tabs 745 and 746 can have a top edge 742a, 742b and a bottom edge 743a, 743b with a front base side tab height (FBSTh) defined therebetween. As embodied herein, the front base panel height (FBPh) is less than the front base side tab height (FBSTh) of each of the first and second front base side tabs 745, 746 to define the recessed area 736 therein. The dimensions of the blank 700 can be selected to provide a container of suitable size to contain a desired web material. For example, blanks in accordance with the disclosed subject matter can be used to form containers for storing and dispensing rolls of butcher paper, and the dimensions of the blank can be selected based on the dimensions of the roll of butcher paper to be stored and dispensed. The dimensions of the blank can also be selected based on the configuration of the cutter to be used with a container formed from the blank. For purpose of example and as described above, a cutter can be disposed along the top edge 713 of the front base panel 735, and the dimensions of the blank can be selected to allow the lid portion of the container to be moved to the closed position without interference between the cutter and the lid portion. For example, if a cutter with a larger profile is desired, the front base panel height (FBPh) can be reduced and/or the front base side tab height (FBSTh) can be increased to define a larger recessed area 736.

As further embodied herein, the first front base side tab 745 can include a recess notch 744a defined therein between the top edge 713 of the front base panel 735 and the top edge 742a of the first front base side tab 745. Additionally, and as embodied herein, the second front base side tab 746 can include a recess notch 744b defined therein between the top edge 713 of the front base panel 735 and the top edge 742b of the second front base side tab 746. As described further herein, the recessed area 736 can extend into the recess notches 744a and 744b when the blank 700 is assembled to form a container.

In accordance with the disclosed subject matter, the base portion 780 further includes a bottom panel 725 extending from the front base panel fold line 726 to a back base panel fold line 716. The bottom panel 725 includes opposing first and second bottom side fold lines 750, 751. A first bottom side tab 727 extends from the first bottom side fold line 750, and a second bottom side tab 728 extends from the second bottom side fold line 751. The first bottom side tab 727 includes a first outer side tab segment 729a extending from the first bottom side fold line 750 to a first outer bottom side tab fold line 752a, a first bottom side connection tab segment 730a extending from the first outer bottom side tab fold line 752a to a first bottom side connection tab fold line 753a, and a first inner bottom side tab segment 731a extending from the first bottom side connection tab fold line 753a. As embodied herein, the first inner bottom side tab segment 731a can extend to a first inner bottom side tab fold line 754a and a first inner bottom side locking tab segment 732a can extend from the first inner bottom side tab fold line 754a. Further in accordance with disclosed subject matter, the second bottom side tab 728 includes a second outer side tab segment 729b extending from the second bottom side fold line 751 to a second outer bottom side tab fold line 752b, a second bottom side connection tab segment 730b extending from the second outer bottom side tab fold line 752b to a second bottom side connection tab fold line 753b, and a second inner bottom side tab segment 731b extending from the second bottom side connection tab fold line 753b. As embodied herein the second inner bottom side tab segment 731b can extend to a second inner bottom side tab fold line 754b, and a second inner bottom side locking tab segment 732b can extend from the second inner bottom side tab fold line 754a.

As further embodied herein, the first inner bottom side tab segment 731a can include opposing front and back first inner bottom side tab edges 755a and 756a, and at least one of the front and back first inner bottom side tab edges 755a and 756a can define a first inner side locking tab projection 733a. For purpose of example and as embodied herein, the first inner side locking tab projection 733a can be defined on the back first inner bottom side tab edge 756a, and the first inner side locking tab projection 733a can be configured to engage with the first back side tab 717 in a folded configuration, as described further herein. As further embodied herein, the second inner bottom side tab segment 731b can include opposing front and back second inner bottom side tab edges 755b and 756b, and at least one of the front and back second inner bottom side tab edges 755b and 756b can define a second inner side locking tab projection 733b. For purpose of example and as embodied herein, the second inner side locking tab projection 733b can be defined on the back second inner bottom side tab edge 756b, and the second inner side locking tab projection 733b can be configured to engage with the second back side tab 718 in a folded configuration, as described further herein.

In accordance with the disclosed subject matter, the base portion 780 further includes a back panel 715 extending from the back base panel fold line 716 to a base-lid hinge line 712. The back panel includes opposing first and second back side fold lines 760 and 761. A first back side tab 717 extends from the first back side fold line 760, and a second back side tab 718 extends from the second back side fold line 761.

As embodied herein, the first back side tab 717 can include a first outer back side tab segment 719a extending from the first back side fold line 760 to a first outer back side tab fold line 762a. The first back side tab 717 can further include a first back side connection tab segment 720a extending from the first outer back side tab fold line 762a to a first back side connection tab fold line 763a and a first inner back side tab segment 721a extending from the first back side connection tab fold line 763a to a first inner back side tab fold line764a. The first back side tab 717 can further include a first back side mounting segment 722a extending from the first inner back side tab fold line 764a. As embodied herein, the first back side mounting segment 722a can be configured to be secured to the back panel 715 with the first back side tab 717 in a folded configuration, as described further herein.

As further embodied herein, the second back side tab 718 can include a second outer back side tab segment 719b extending from the second back side fold line 761 to a second outer back side tab fold line 762b. The second back side tab 718 can further include a second back side connection tab segment 720b extending from the second outer back side tab fold line 762b to a second back side connection tab fold line 763b and a second inner back side tab segment 721b extending from the second back side connection tab fold line 763b to a second inner back side tab fold line 764b. The second back side tab 718 can further include a second back side mounting segment 722b extending from the second inner back side tab fold line 764b. As embodied herein, the second back side mounting segment 722b can be configured to be secured to the back panel 715 with the second back side tab 718 in a folded configuration, as described further herein.

In accordance with the disclosed subject matter, the blank 700 further includes a lid portion 781. The lid portion includes a top panel 711 extending from the base-lid hinge line 712 to a top front fold line 706 and a front lid panel 701 extending from the top front fold line 706. As embodied herein, the front lid panel 701 can extend to a lid closing edge 708 opposite the top front fold line 706. As further embodied herein, the front lid panel 701 can further include first and second front lid side edges 770 and 771 defining a front lid panel width (FPw) therebetween. The front lid panel 701 can further include a first front lid side notch 702 defined between the lid closing edge 708 and the first front lid side edge 770 and a second front lid side notch 704 defined between the lid closing edge 708 and the second front lid side edge 771. As embodied herein, the lid closing edge 708 can have a lid closing edge width (LCEw) less than the front panel width (FPw). The first and second front lid side notches 702 and 704 can have any desirable shape. For example, the first and second front lid side notches 702 and 704 can have a curved shape extending between the lid closing edge 708 and the first and second front lid side edges 770 and 771, respectively. Additionally or alternatively, and as embodied herein, the first and second front lid side notches 702 and 704 can have an angled shape extending between the lid closing edge 708 and the first and second front lid side edges 770 and 771, respectively.

As further embodied herein, each of the first and second front lid side edges 770 and 771 can have a setback 703 and 705 defined therein between the top front fold line 706 and the respective front lid side notch 702 and 704.

The disclosed subject matter further includes methods of forming blanks into containers. Methods in accordance with the disclosed subject matter include providing a blank as described above. Methods in accordance with the disclosed subject matter further include folding the front base panel about the front base panel fold line to define a front of a compartment and folding the back panel about the back base panel fold line to define a back of the compartment. Methods in accordance with the disclosed subject matter further include folding the first front base side tab about the first front base side fold line, the first back side tab about the first back side fold line, and the first bottom side tab about the first bottom side fold line, first outer bottom side tab fold line, and the first bottom side connection tab fold line to define a first side of the compartment. Methods in accordance with the disclosed subject matter further include folding the second front base side tab about the second front base side fold line, the second back side tab about the second back side fold line, and the second bottom side tab about the second bottom side fold line, second outer bottom side tab fold line and the second bottom side connection tab fold line to define a second side of the compartment. Methods in accordance with the disclosed subject matter further include folding the top panel about the base-lid hinge line to define a top of the compartment.

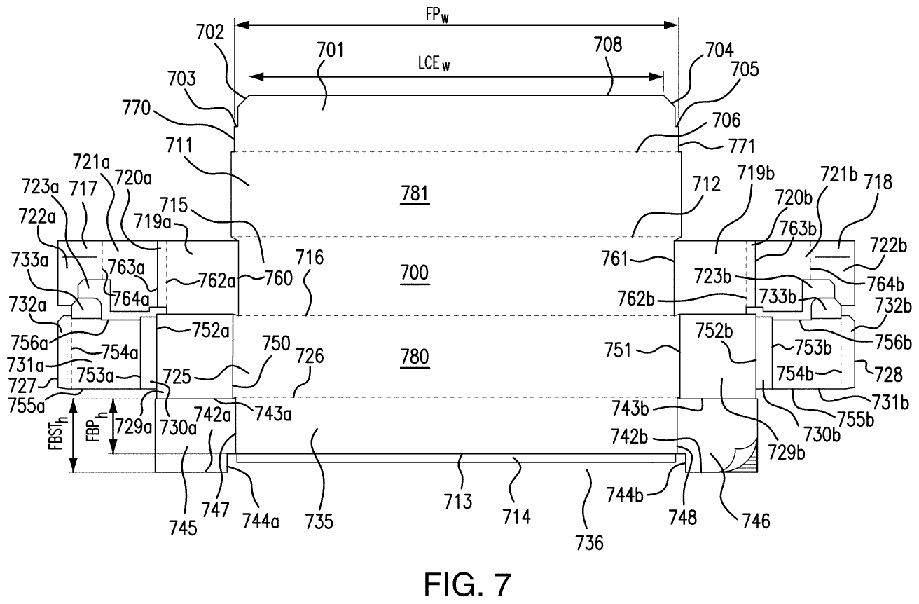

For purpose of illustration and not limitation, FIGS. 8-12B illustrate an exemplary method of constructing a container from the blank 700. With reference to FIG. 8, and as embodied herein for illustration and not limitation, the first and second back side tabs 717 and 718 can be folded and secured to the back panel 715 to begin defining sides of a compartment. As embodied herein, the first back side tab 717 can be folded about the first outer back side tab fold line 762a and the first back side connection tab fold line 763a to bring the first back side mounting segment 722a into contact with the back panel 715. As further embodied herein, the second side tab 718 can be folded about the second outer back side tab fold line 762b and the second back side connection tab fold line 763b to bring the second back side mounting segment 722b into contact with the back panel 715. The first and second back side mounting segments 722a and 722b can be secured to the back panel 715 using any suitable means. As embodied herein, the first and second back side mounting segments 722a and 722b can be secured to the back panel 715 using adhesive.

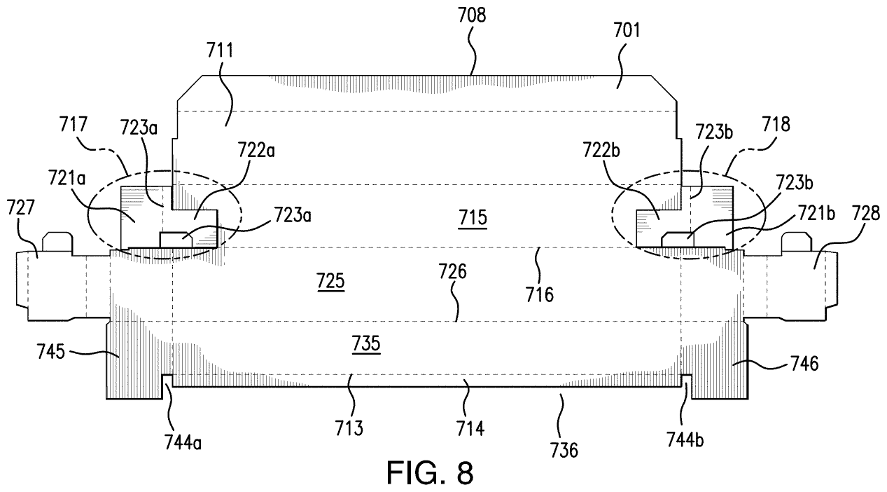

With reference to FIG. 9, assembling the blank into a container can further include folding the first and second back side tabs 717 and 718 towards one another to further define sides of a compartment. As embodied herein, the first and second back side tabs 717 and 718 can be folded about first and second inner back side tab fold lines 764a and 764b with the first and second back side mounting segments 722a and 722b secured to the back panel 715. As embodied herein, the first and second inner back side tab segments 721a and 721b can be perpendicular to the back panel 715 with the first and second back side tabs 717 and 718 folded about the first and second inner back side tab fold lines 764a and 764b. As embodied herein, the first and second back side tabs 717 and 718 can include first and second back side tab notches 723a and 723b, which can be configured to receive the first and second inner side locking tab projections 733a and 733b, respectively, as described further herein.

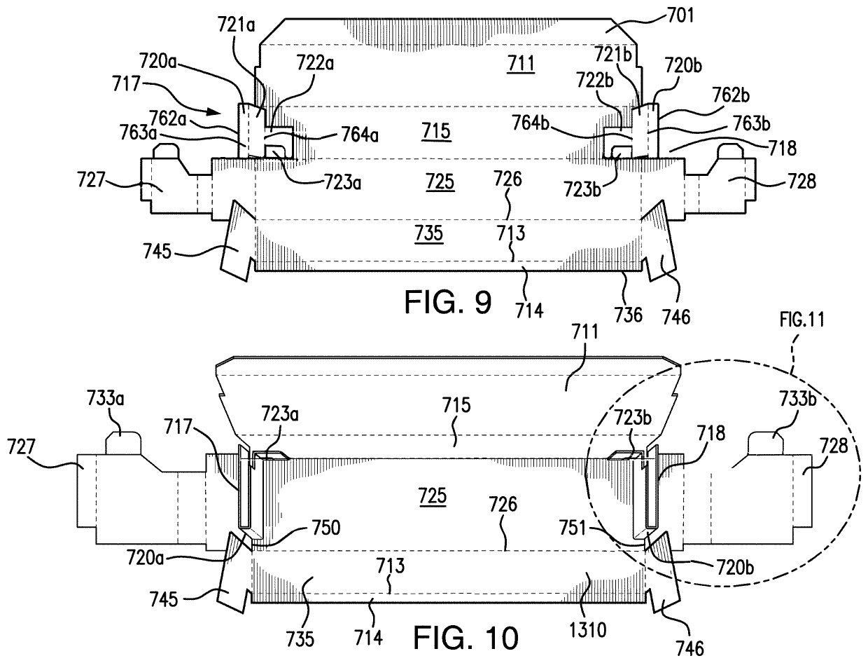

With reference to FIG. 10, assembling the blank 700 into a container can further include folding the back panel 715 about the back base panel fold line 716 to define a back of the compartment. As embodied herein, the first and second back side tabs 717 and 718 can extend between the back panel 715 and the bottom panel 725 to define opposing sides of the compartment. For example, and as embodied herein, the first back side tab 717 can have a folded configuration with the first outer back side tab segment 719a extending from the back panel 715 towards the front base panel 735. The first back side connection tab segment 720a can extend generally parallel to the back panel 715, and the first inner back side tab segment 721a can extend from the first back side connection tab segment 720a towards the back panel 715. As further embodied herein, the first back side mounting segment 722a can extend from the first inner back side tab segment 721a, and the first back side mounting segment 722a can be secured to the back panel 715. Additionally or alternatively, the second back side tab 718 can have a folded configuration with the second outer back side tab segment 719b extending from the back panel 715 towards the front base panel 735. The second back side connection tab segment 720b can extend generally parallel to the back panel 715, and the second inner back side tab segment 721b can extend from the second back side connection tab segment 720b towards the back panel 715. As further embodied herein, the second back side mounting segment 722b can extend from the second inner back side tab segment 721b, and the second back side mounting segment 722b can be secured to the back panel 715. As described further herein, the first and second back side connection tab segments 720a and 720b can be spaced from the front panel 735 in the folded configuration with the recessed area 736 extending into the first and second side tabs.

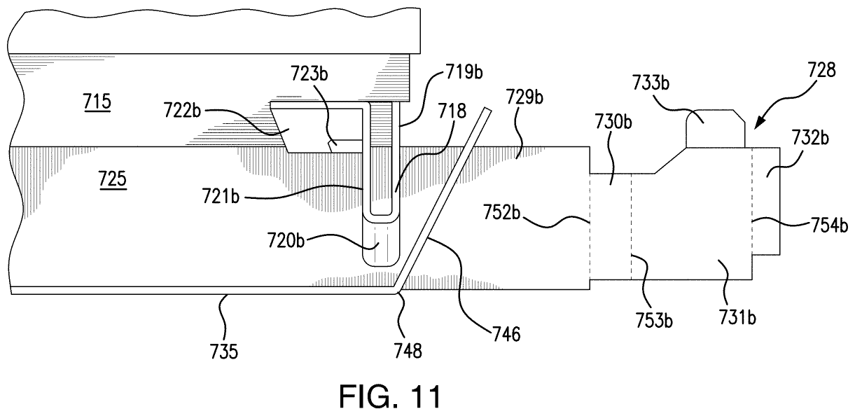

With reference to FIGS. 10 and 11, assembling the blank 700 into a container can further include folding the front base panel 735 about the front base panel fold line 726 to define a front of the compartment. Assembling the blank 700 into a container can further include folding the first and second front base side tabs 745 and 746 about the first and second front base side fold lines 747 and 748 to further define the sides of the compartment. As embodied herein, the first and second front base side tabs 745 and 746 can extend between the front base panel 735, bottom panel 725 and the back panel 715 along the first and second outer back side tab segments 719a and 719b. As described further herein, the first and second front base side tabs 745 and 746 can include recess notches 744a and 744b defined therein, and the recessed area 736 can extend into the recess notches 744a and 744b.

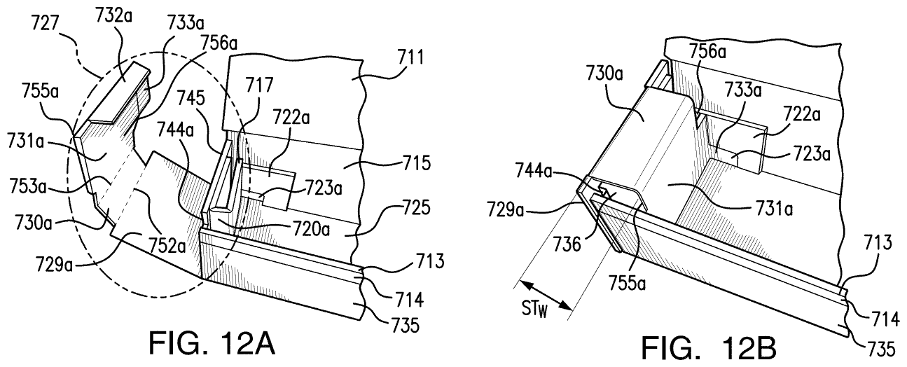

With reference to FIG. 12A, assembling the blank 700 into a container can further include folding the first and second bottom side tabs 727 and 728 to further define the opposing sides of the compartment. As embodied herein, the first bottom side tab 727 can extend from the first bottom side fold line 750 of the bottom panel 725 and around the first front base side tab 745 and the first back side tab 717. As embodied herein, the first bottom side tab 727 can include a first outer side tab segment 729a and a first inner bottom side tab segment 731a with the first front base side tab 745 and first back side tab 717 therebetween in the folded configuration. As further embodied herein, the first inner bottom side tab segment 731a can include opposing front and back first inner bottom side tab edges 755a and 756a, and at least one of the first inner bottom side tab edges 755a and 756a can define a first inner side locking tab projection 733a. As embodied herein, the first inner side locking tab projection 733a can be defined on the back first inner bottom side tab edge 756a and configured to engage with the first back side tab 717 in the folded condition. For purpose of example and as embodied herein, the first inner side locking tab projection 733a can engage with the first back side tab notch 723a to secure the first bottom side tab 727 in the folded configuration.

As further embodied herein, the second bottom side tab 728 can extend from the second bottom side fold line 751 of the bottom panel 725 and around the second front base side tab 746 and the second back side tab 718. As embodied herein, the second bottom side tab 728 can include a second outer side tab segment 729b and a second inner bottom side tab segment 731b with the second front base side tab 746 and second back side tab 718 therebetween in the folded configuration. As further embodied herein, the second inner bottom side tab segment 731b can include opposing front and back second inner bottom side tab edges 755b and 756b, and at least one of the second inner bottom side tab edges 755b and 756b can define a second inner side locking tab projection 733b. As embodied herein, the second inner side locking tab projection 733b can be defined on the back second inner bottom side tab edge 756b and configured to engage with the second back side tab 718 in the folded condition. For purpose of example and as embodied herein, the second inner side locking tab projection 733b can engage with the second back side tab notch 723b to secure the second bottom side tab 728 in the folded configuration.

With reference to FIG. 12B, the blank 700 is depicted in an assembled configuration with the first inner side locking tab projection 733a engaged with the first back side tab notch 723a to secure the first bottom side tab 727 in the folded configuration. As embodied herein, the first inner side locking tab projection 733a can be folded about the back second inner bottom side tab edge 756b to engage the first inner side locking tab projection 733a with the first back side tab notch 723a. As embodied herein, the first inner side locking tab projection 733a can extend generally parallel with the back panel 715 when engaged with the first back side tab notch 723a. The second inner side locking tab projection 733b can engage with the second back side tab notch 723b in a similar manner to secure the second bottom side tab 728 in the folded configuration.

In accordance with the disclosed subject matter, the top edge 713 defines a recessed area 736. As embodied herein, the recessed area 736 can receive a cutter, as described above. As embodied herein, the recessed area 736 can extend into the first and second side tabs. For purpose of example and as embodied herein, the recessed area 736 can be further defined between the top edge 713 and the first bottom side connection tab segment 730a and the first inner bottom side tab segment 731a. As further embodied herein, the recessed area 736 can be further defined between the top edge 713 and first front base side tab 745 in the recess notch 744a. As described above, a side tab width (STw) can be defined between the first and second outer side tab segments 729a and 729b and the first and second inner bottom side tab segments 731a and 731b. For example and as embodied herein, the side tab width can be defined by the first and second bottom side connection tab segments 730a and 730b, respectively. The side tab width can be selected to position a roll of web material in the center of the container compartment between first and second inner bottom side tab segments 731a and 731b. Centering the roll of web material in the compartment using first and second inner bottom side tab segments 731a and 731b can avoid the need for additional components, such as plugs or excess core material. Additionally or alternatively, the side tab width (STw) can be selected to accommodate a cutter in the recessed area defined within the first and second side tabs, respectively.

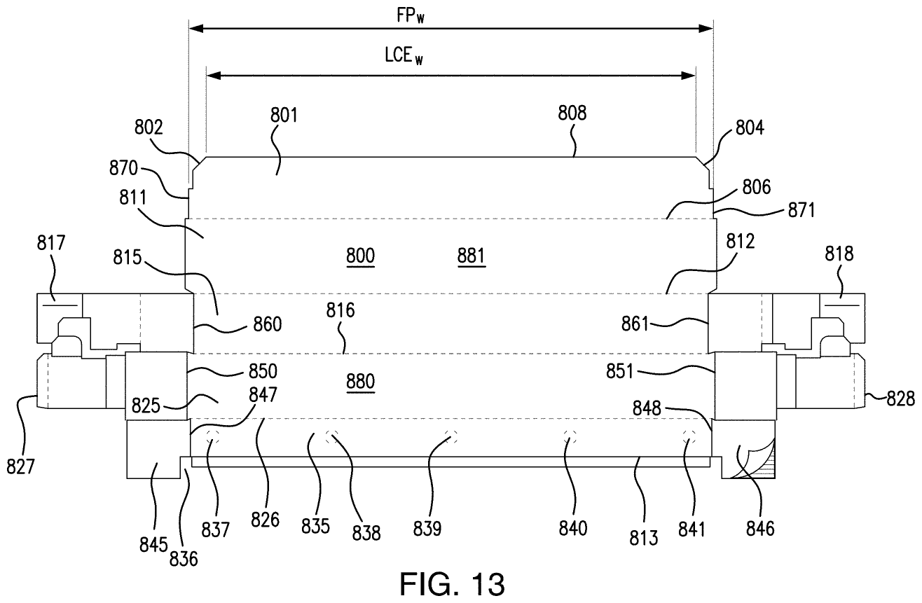

For purpose of example and not limitation, additional embodiments of blanks in accordance with the disclosed subject matter are shown in FIGS. 13-15. With reference to FIG. 13, a blank 800 is depicted. In accordance with the disclosed subject matter, the blank 800 includes a base portion 880 having a front base panel 835. The front base panel 835 includes a top edge 813 defining a recessed area 836, and a front base panel fold line 826 opposite the top edge 813. As embodied herein, the front base panel 835 can include glue points. For example and not limitation, and as embodied herein, the front base panel 835 can include five glue points 837, 838, 839, 840, and 841. The glue points can be used, for example, to secure a lid of a container formed from the blank 800 in a closed position.

The front base panel 835 further includes opposing first and second front base side fold lines 847, 848. A first front base side tab 845 extends from the first front base side fold line 847, and a second front base side tab 846 extends from the second front base side fold line 848.

The base portion 880 further includes a bottom panel 825 extending from the front base panel fold line 826 to a back base panel fold line 816. The bottom panel 825 includes opposing first and second bottom side fold lines 850, 851. A first bottom side tab 827 extends from the first bottom side fold line 850, and a second bottom side tab 828 extends from the second bottom side fold line 851.

The base portion 880 further includes a back panel 815 extending from the back base panel fold line 816 to a base-lid hinge line 812. The back panel includes opposing first and second back side fold lines 860 and 861. A first back side tab 817 extends from the first back side fold line 860, and a second back side tab 818 extends from the second back side fold line 861.

In accordance with the disclosed subject matter, the blank 800 further includes a lid portion 881. The lid portion includes a top panel 811 extending from the base-lid hinge line 812 to a top front fold line 806 and a front lid panel 801 extending from the top front fold line 806 to a lid closing edge 808 opposite the top front fold line 806. The front lid panel 801 further includes first and second front lid side edges 870 and 871 defining a front lid panel width (FPw) therebetween. The front lid panel 801 further includes a first front lid side notch 802 defined between the lid closing edge 808 and the first front lid side edge 870 and a second front lid side notch 804 defined between the lid closing edge 808 and the second front lid side edge 871. The lid closing edge 808 has a lid closing edge width (LCEw) less than the front panel width (FPw).

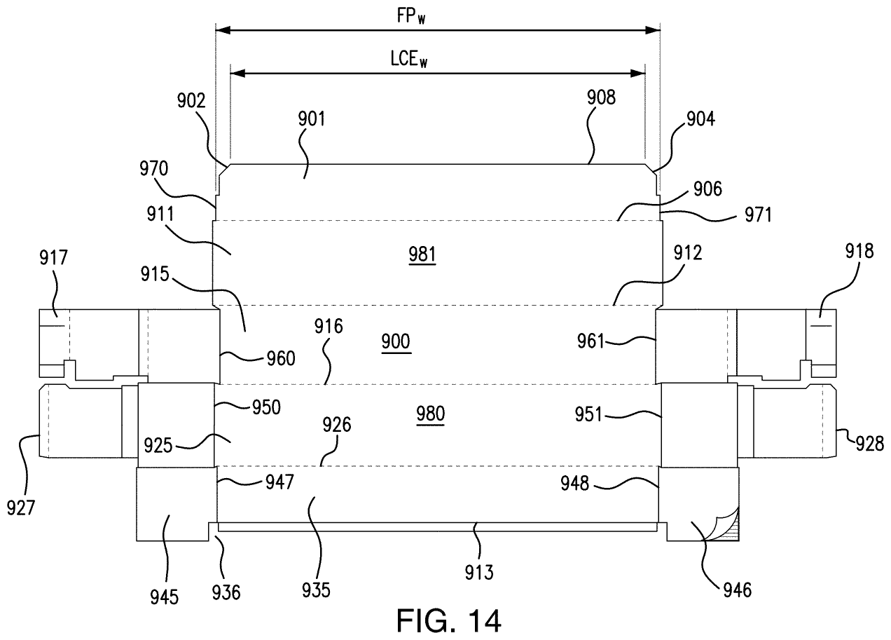

With reference to FIG. 14, a blank 900 is depicted. In accordance with the disclosed subject matter, the blank 900 includes a base portion 980 having a front base panel 935. The front base panel 935 includes a top edge 913 defining a recessed area 936, and a front base panel fold line 926 opposite the top edge 913. The front base panel 935 further includes opposing first and second front base side fold lines 947, 948. A first front base side tab 945 extends from the first front base side fold line 947, and a second front base side tab 946 extends from the second front base side fold line 948.

The base portion 980 further includes a bottom panel 925 extending from the front base panel fold line 926 to a back base panel fold line 916. The bottom panel 925 includes opposing first and second bottom side fold lines 950, 951. A first bottom side tab 927 extends from the first bottom side fold line 950, and a second bottom side tab 928 extends from the second bottom side fold line 951.

The base portion 980 further includes a back panel 915 extending from the back base panel fold line 916 to a base-lid hinge line 912. The back panel includes opposing first and second back side fold lines 960 and 961. A first back side tab 917 extends from the first back side fold line 960, and a second back side tab 918 extends from the second back side fold line 961.

In accordance with the disclosed subject matter, the blank 900 further includes a lid portion 981. The lid portion includes a top panel 911 extending from the base-lid hinge line 912 to a top front fold line 906 and a front lid panel 901 extending from the top front fold line 906 to a lid closing edge 908 opposite the top front fold line 906. The front lid panel 901 further includes first and second front lid side edges 970 and 971 defining a front lid panel width (FPw) therebetween. The front lid panel 901 further includes a first front lid side notch 902 defined between the lid closing edge 908 and the first front lid side edge 970 and a second front lid side notch 904 defined between the lid closing edge 908 and the second front lid side edge 971. The lid closing edge 908 has a lid closing edge width (LCEw) less than the front panel width (FPw).

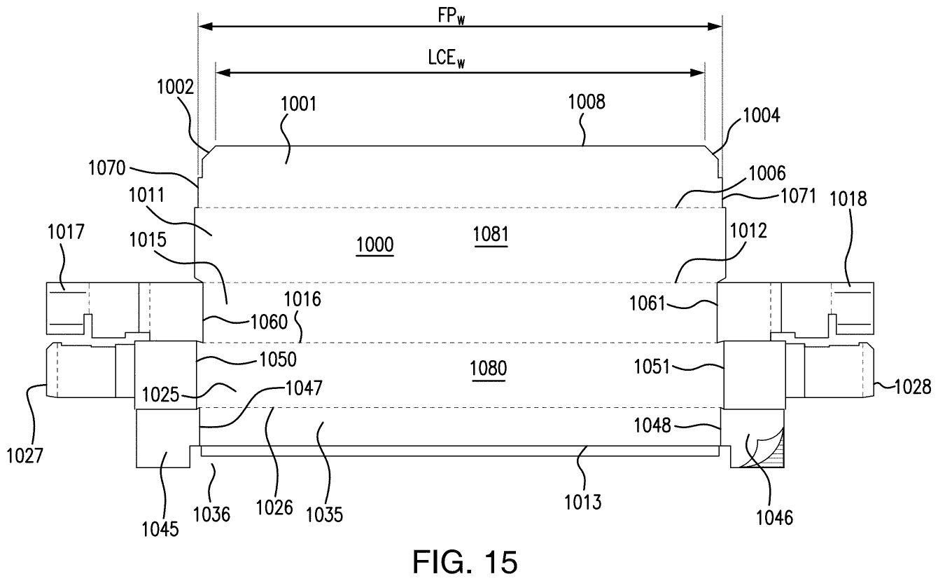

With reference to FIG. 15, a blank 1000 is depicted. In accordance with the disclosed subject matter, the blank 1000 includes a base portion 1080 having a front base panel 1035. The front base panel 1035 includes a top edge 1013 defining a recessed area 1036, and a front base panel fold line 1026 opposite the top edge 1013. The front base panel 1035 further includes opposing first and second front base side fold lines 1047, 1048. A first front base side tab 1045 extends from the first front base side fold line 1047, and a second front base side tab 1046 extends from the second front base side fold line 1048.

The base portion 1080 further includes a bottom panel 1025 extending from the front base panel fold line 1026 to a back base panel fold line 1016. The bottom panel 1025 includes opposing first and second bottom side fold lines 1050, 1051. A first bottom side tab 1027 extends from the first bottom side fold line 1050, and a second bottom side tab 1028 extends from the second bottom side fold line 1051.

The base portion 1080 further includes a back panel 1015 extending from the back base panel fold line 1016 to a base-lid hinge line 1012. The back panel includes opposing first and second back side fold lines 1060 and 1061. A first back side tab 1017 extends from the first back side fold line 1060, and a second back side tab 1018 extends from the second back side fold line 1061.

In accordance with the disclosed subject matter, the blank 1000 further includes a lid portion 1081. The lid portion includes a top panel 1011 extending from the base-lid hinge line 1012 to a top front fold line 1006 and a front lid panel 1001 extending from the top front fold line 1006 to a lid closing edge 1008 opposite the top front fold line 1006. The front lid panel 1001 further includes first and second front lid side edges 1070 and 1071 defining a front lid panel width (FPw) therebetween. The front lid panel 1001 further includes a first front lid side notch 1002 defined between the lid closing edge 1008 and the first front lid side edge 1070 and a second front lid side notch 1004 defined between the lid closing edge 1008 and the second front lid side edge 1071. The lid closing edge 1008 has a lid closing edge width (LCEw) less than the front panel width (FPw).

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A container for dispensing web material, the container comprising:
a base portion defining a compartment, the base portion having:
a bottom panel defining a bottom of the compartment,
a front base panel defining a front of the compartment, the front base panel extending upwardly from the bottom panel to a top edge defining a recessed area,
a back panel extending from the bottom panel to define a back of the compartment, and
first and second side tabs extending between the bottom panel, the front base panel, and the back panel at opposing sides thereof to define opposing sides of the compartment; and
a lid portion, the lid portion moveable between an open position for access to the compartment and a closed position, the lid portion having:
a top panel defining a top of the lid portion, the top panel hingedly-coupled to the back panel, and
a front lid panel extending from the top panel, wherein the front lid panel covers the recessed area in the closed position, and wherein in the open position, web material can be dispensed from the compartment through the recessed area.

2. The container of claim 1, wherein the front base panel has a front base panel height defined between the top edge and the bottom panel, and each of the first and second side tabs has a top edge and a bottom edge with a side tab height defined therebetween, wherein the front base panel height is less than the side tab height of each of the first and second side tabs to define the recessed area therein.

3. The container of claim 2, further comprising a cutter disposed on the front base panel in the recessed area.

4. The container of claim 3, wherein a cutter height is defined between the bottom panel and a cutter high point, wherein the cutter height is less than the side tab height of each of the first and second side tabs.

5. The container of claim 1, wherein each of the first and second side tabs has a recess notch therein between the top edge of the front base panel and the top edge of the respective front base side tab.

6. The container of claim 1, wherein a roll of web material is contained within the compartment.

7. The container of claim 6, wherein the roll of web material is a roll of butcher paper.

8. The container of claim 1, wherein the first side tab comprises a first bottom side tab extending from a first side of the bottom panel, the first bottom side tab having a first outer side tab segment, a first inner bottom side tab segment, and a first bottom side connection tab segment therebetween to define a first side tab width,
and further wherein the second side tab comprises a second bottom side tab extending from a second side of the bottom panel, the second bottom side tab having a second outer side tab segment, a second inner bottom side tab segment, and a second bottom side connection tab segment therebetween to define a second side tab width.

9. The container of claim 8, wherein the first side tab further includes a first front base side tab extending from a first side of the front base panel and a first back side tab extending from a first side of the back panel, the first front base side tab and the first back side tab secured between the first outer side tab segment and the first inner bottom side tab segment,
and further wherein, the second side tab further includes a second front base side tab extending from a second side of the front base panel and a second back side tab extending from a second side of the back panel, the second front base side tab and the second back side tab secured between the second outer side tab segment and the second inner bottom side tab segment.

10. The container of claim 9, wherein the first back side tab has a folded configuration, with a first outer back side tab segment extending from the back panel towards the front base panel, a first back side connection tab segment extending generally parallel to the back panel, a first inner back side tab segment extending from the first back side connection tab segment towards the back panel, and a first back side mounting segment extending from the first inner back side tab segment, the first back side mounting segment secured to the back panel,
and further wherein the second back side tab has a folded configuration, with a second outer back side tab segment extending from the back panel towards the front base panel, a second back side connection tab segment extending generally parallel to the back panel, a second inner back side tab segment extending from the second back side connection tab segment towards the back panel, and a second back side mounting segment extending from the second inner back side tab segment, the second back side mounting segment secured to the back panel.

11. The container of claim 1, wherein the front lid panel extends from the top panel to a lid closing edge, the front lid panel having first and second front lid side edges defining a front lid panel width therebetween, each of the first and second front lid side edges having a setback defined therein between the top panel and the lid closing edge, wherein the lid closing edge has a lid closing edge width less than the front lid panel width.

12. A blank comprising:
a base portion having:
a front base panel comprising a top edge and a front base panel fold line opposite the top edge, the front base panel having opposing first and second front base side fold lines, a first front base side tab extending from the first front base side fold line and a second front base side tab extending from the second front base side fold line,
a bottom panel extending from the front base panel fold line to a back base panel fold line, the bottom panel having opposing first and second bottom side fold lines, a first bottom side tab extending from the first bottom side fold line and a second bottom side tab extending from the second bottom side fold line, wherein the first bottom side tab comprises a first outer side tab segment extending from the first bottom side fold line to a first outer bottom side tab fold line, a first bottom side connection tab segment extending from the first outer bottom side tab fold line to a first bottom side connection tab fold line, and a first inner bottom side tab segment extending from the first bottom side connection tab fold line, and wherein the second bottom side tab comprises a second outer side tab segment extending from the second bottom side fold line to a second outer bottom side tab fold line, a second bottom side connection tab segment extending from the second outer bottom side tab fold line to a second bottom side connection tab fold line, and a second inner bottom side tab segment extending from the second bottom side connection tab fold line and
a back panel extending from the back base panel fold line to a base-lid hinge line, the back panel having opposing first and second back side fold lines, a first back side tab extending from the first back side fold line and a second back side tab extending from the second back side fold line; and
a lid portion having:
a top panel extending from the base-lid hinge line to a top front fold line, and
a front lid panel extending from the top front fold line.

13. The blank of claim 12, further comprising a reinforcement panel extending from the top edge of the front base panel, wherein the top edge is a top edge fold line.

14. The blank of claim 12, wherein the top edge defines a recessed area.

15. The blank of claim 14, wherein the front base panel has a front base panel height defined between the top edge and the front base panel fold line, and each of the first and second front base side tabs has a top edge and a bottom edge with a front base side tab height defined therebetween, wherein the front base panel height is less than the front base side tab height of each of the first and second front base side tabs to define the recessed area therein.

16. The blank of claim 14, wherein each of the first and second front base side tabs has a recess notch therein between the top edge of the front base panel and the top edge of the respective front base side tab.

17. The blank of claim 12, wherein the front lid panel includes first and second front lid side edges defining a front lid panel width therebetween and a lid closing edge opposite the top front fold line, each of the first and second front lid side edges includes a setback defined therein between the top front fold line and the lid closing edge, wherein the lid closing edge has a lid closing edge width less than the front lid panel width.

18. The blank of claim 12, wherein the front lid panel further includes a first front lid side notch defined between the lid closing edge and the first front lid side edge and a second front lid side notch defined between the lid closing edge and the second front lid side edge.

19. The blank of claim 18, wherein the each of the first and second front lid side notches has an angled or curved shape extending between the lid closing edge and the first and second front lid side edge, respectively.

20. The blank of claim 12, wherein the top front fold line comprises at least one score line.

21. The blank of claim 12, wherein the first inner bottom side tab segment extends from the first bottom side connection tab fold line to a first inner bottom side tab fold line, and a first inner bottom side locking tab segment extends from the first inner bottom side tab fold line, and wherein the second inner bottom side tab segment extends from the second bottom side connection tab fold line to a second inner bottom side tab fold line, and a second inner bottom side locking tab segment extends from the second inner bottom side tab fold line.

22. The blank of claim 12, wherein the first inner bottom side tab segment has opposing front and back first inner bottom side tab edges and at least one of the front and back first inner bottom side tab edges defines a first inner side locking tab projection, and wherein the second inner bottom side tab segment has opposing front and back second inner bottom side tab edges and at least one of the front and back second inner bottom side tab edges defines a second inner side locking tab projection

23. The blank of claim 22, wherein the first inner side locking tab projection is defined on the back first inner bottom side tab edge and configured to engage with the first back side tab in a folded configuration, and wherein the second inner side locking tab projection is defined on the back second inner bottom side tab edge and configured to engage with the second back side tab in a folded configuration.

24. The blank of claim 12, wherein the first back side tab comprises a first outer back side tab segment extending from the first back side fold line to a first outer back side tab fold line, a first back side connection tab segment extending from the first outer back side tab fold line to a first back side connection tab fold line, and a first inner back side tab segment extending from the first back side connection tab fold line to a first inner back side tab fold line, and a first back side mounting segment extending from the first inner back side tab fold line, and
wherein the second back side tab comprises a second outer back side tab segment extending from the second back side fold line to a second outer back side tab fold line, a second back side connection tab segment extending from the second outer back side tab fold line to a second back side connection tab fold line, and a second inner back side tab segment extending from the second back side connection tab fold line to a second inner back side tab fold line, and a second back side mounting segment extending from the second inner back side tab fold line.

25. The blank of claim 24, wherein first and second back side mounting segments are configured to be secured to the back panel with the first and second back side tabs in a folded configuration.

26. The blank of claim 24, wherein the first and second back side mounting segments each include a notch configured to receive a locking tab.

27. A method of forming a blank into a container, the method comprising:
providing a blank having a base portion and a lid portion,
the base portion including:
a front base panel comprising a top edge and a front base panel fold line opposite the top edge, the front base panel having opposing first and second front base side fold lines, a first front base side tab extending from the first front base side fold line and a second front base side tab extending from the second front base side fold line,
a bottom panel extending from the front base panel fold line to a back base panel fold line, the bottom panel having opposing first and second bottom side fold lines, a first bottom side tab extending from the first bottom side fold line and a second bottom side tab extending from the second bottom side fold line, wherein the first bottom side tab comprises a first outer side tab segment extending from the first bottom side fold line to a first outer bottom side tab fold line, a first bottom side connection tab segment extending from the first outer bottom side tab fold line to a first bottom side connection tab fold line, and a first inner bottom side tab segment extending from the first bottom side connection tab fold line, and wherein the second bottom side tab comprises a second outer side tab segment extending from the second bottom side fold line to a second outer bottom side tab fold line, a second bottom side connection tab segment extending from the second outer bottom side tab fold line to a second bottom side connection tab fold line, and a second inner bottom side tab segment extending from the second bottom side connection tab fold line and
a back panel extending from the back base panel fold line to a base-lid hinge line, the back panel having opposing first and second back side fold lines, a first back side tab extending from the first back side fold line and a second back side tab extending from the second back side fold line; and
the lid portion including a top panel extending from the base-lid hinge line to a top front fold line, and a front lid panel extending from the top front fold line;
folding the front base panel about the front base panel fold line to define a front of a compartment,
folding the back panel about the back base panel fold line to define a back of the compartment,
folding the first front base side tab about the first front base side fold line, the first back side tab about the first back side fold line, and the first bottom side tab about the first bottom side fold line, first outer bottom side tab fold line, and the first bottom side connection tab fold line to define a first side of the compartment,
folding the second front base side tab about the second front base side fold line, the second back side tab about the second back side fold line, and the second bottom side tab about the second bottom side fold line, second outer bottom side tab fold line, and the second bottom side connection tab fold line to define a second side of the compartment, and
folding the top panel about the base-lid hinge line to define a top of the compartment.

28. The method of claim 27, wherein the first bottom side tab is folded around the first front base side tab and the first back side tab, the first front base side tab and the first back side tab extending between the first outer side tab segment and the first inner bottom side tab segment, and
wherein the second bottom side tab is folded around the second front base side tab and the second back side tab, the second front base side tab and the second back side tab extending between the second outer side tab segment and the second inner bottom side tab segment.

29. The method of claim 27, wherein the first back side tab comprises a first back side mounting segment and wherein folding the first back side tab includes securing the first back side mounting segment to the back panel,
and further wherein, the second back side tab comprises a second back side mounting segment and wherein folding the second back side tab includes securing the second back side mounting segment to the back panel.

30. The method of claim 29, wherein the first back side mounting segment includes a first back side tab notch, and the second back side mounting segment includes a second back side tab notch,
and further wherein the first inner bottom side tab segment includes a first inner side locking tab projection, and the second inner bottom side tab segment includes a second inner side locking tab projection,
wherein folding the first bottom side tab includes engaging the first inner side locking tab projection with the first back side tab notch, and folding the second bottom side tab includes engaging the second inner side locking tab projection with the second back side tab notch.
